(19) United States
(12) Patent Application Publication
(10) Pub. No.: US 2014/0311829 A1
(43) Pub. Date: Oct. 23, 2014

(54) TREE STAND

(71) Applicant: DDI, Inc., Dubuque, IA (US)

(72) Inventors: John Brian Priest, Dubuque, IA (US); Christopher L. Johnson, Dubuque, IA (US); Nena M. Speder, Brookfield, WI (US); Brandon J. Krupp, Fond du Lac, WI (US); James L. Bell, Hazel Green, WI (US); Michael J. Butalla, Marathon, WI (US); Brennan D. Seeliger, Appleton, WI (US); Bradley W. Davis, Neenah, WI (US); Jennifer B. Goninen, Dickeyville, WI (US)

(21) Appl. No.: 13/959,687

(22) Filed: Aug. 5, 2013

Related U.S. Application Data
(60) Provisional application No. 61/815,246, filed on Apr. 23, 2013.

(51) Int. Cl. A01M 31/02

(52) U.S. Cl. CPC A01M 31/02
USPC 182/187

(57) ABSTRACT

A tree stand platform support comprises a post comprising a first plate portion, a second plate portion parallel to the first plate portion and an intermediate open celled web portion interconnecting and extending perpendicular to the first plate portion and the second plate portion. The intermediate open celled web portion has cell walls forming cell openings through the intermediate open celled web portion.

### CROSS-REFERENCE TO RELATED PATENT APPLICATIONS

The present application claims priority under 35 USC Section 120 from co-pending U.S. Provisional Application Ser. No. 61/815,246 filed on Apr. 23, 2013 by Priest et al. and entitled TREE STAND, full disclosure of which is hereby incorporated by reference.

### BACKGROUND

Tree stands are used to elevate a person above the ground on a tree to facilitate hunting or wildlife observation. Existing tree stands are frequently heavy and cumbersome to transport and difficult to set up. Existing tree stands are many times conspicuous to wildlife and undesirably reverberate noise to make hunting and wildlife observation more difficult.

### BRIEF DESCRIPTION OF THE DRAWINGS

FIG. 1 is a perspective view of an example tree stand mounted to a tree trunk.

FIG. 2 is a perspective view of a tree connect of the tree stand of FIG. 1 mounted to the tree trunk.

FIG. 3 is a front view of the tree connect of FIG. 2 mounted to the tree trunk.

FIG. 4 is a front perspective view of a body of the tree connect of FIG. 3.

FIG. 5 is a rear perspective view of the body of the tree trunk of FIG. 3.

FIG. 6 is a top perspective view of the body of the tree connect of FIG. 3.

FIG. 7 is a perspective view of an example catch of the tree connect of FIG. 3.

FIG. 8 is a perspective view of an example faster for mounting the catch of FIG. 7 to the body of FIG. 3.

FIG. 9 is a front perspective view of an assembled tree connect of the tree stand of FIG. 1.

FIG. 10 is a top perspective view of the assembled tree connect of FIG. 9.

FIG. 11 is a side view of an example support post connected to the tree connect of FIG. 9.

FIG. 12 is a front perspective view of the support post and tree connect of FIG. 11.

FIG. 13 is a front perspective view of a lower portion of the support post of FIG. 12.

FIG. 14 is a front perspective view of the support post and tree connect of FIG. 12.

FIG. 15 is a sectional view of the support post and tree connect of FIG. 14.

FIG. 16 is a rear perspective view of the support post of FIG. 14.

FIG. 17 is a rear perspective view of an upper portion of the support post of FIG. 16.

FIG. 18 is a front perspective view of the support post and tree connect of FIG. 14.

FIG. 19 is an enlarged side view of the support post and tree connect of FIG. 14.

FIG. 20 is a sectional view of the support post and tree connect of FIG. 14.

FIG. 21 is a sectional view of the support post and tree connect of FIG. 14.

### DETAILED DESCRIPTION OF THE EXAMPLE EMBODIMENTS

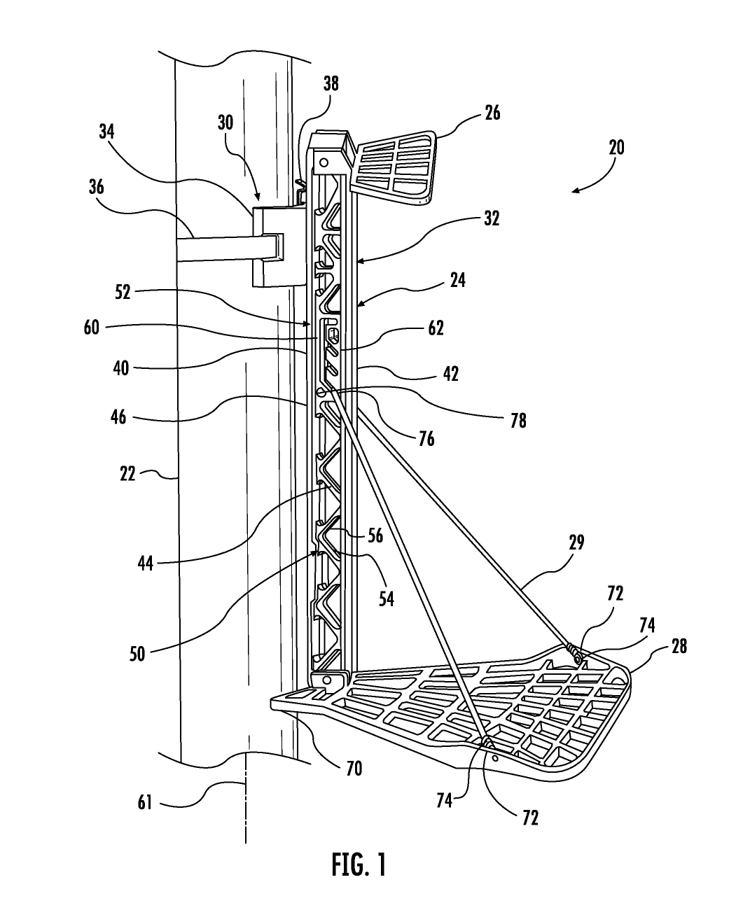

FIG. 1 is a perspective view of an example tree stand 20 mounted to a tree trunk 22. Tree stand 20 is mounted to the tree and provides one or more platforms upon which a person hunting or observing wildlife may stand or be seated. As will be described hereafter, tree stand 20 supports the person with reduced noise, allowing a person to be more inconspicuous and enhancing such hunting or wildlife observation. As compared to existing tree stands, tree stand 20 casts less conspicuous shadows and allows background environment to be seen through the post of tree stand 20, camouflaging tree stand 20. In addition, tree stand 20 is lightweight and easy to set up. Tree stand 20 comprises tree stand platform support 24, seat platform 26, foot platform 28 and platform support line 29.

Tree stand platform support 24 supports seat platform 26 and foot platform 28 while mounting such platforms to a tree, such as trunk 22 of a tree. Tree stand platform support 24 comprises tree connect 30 and support post 32. Tree connect 30 comprises one or more structures that interface between support post 32 and tree trunk 22. In the example illustrated, tree connect 30 comprises body 34, tree wrap 36 and catch 38. Body 34 partially extends about tree trunk 22. Tree wrap 36 encircles a remainder of tree trunk 22. In one implementation, tree wrap 36 comprises a strap. In another implementation, tree wrap 36 comprises a belt or other tree gripping flexible member.

Catch 38 comprise a hook, pin, snap or other member configured to releasably engage post 32 to inhibit relative movement of post 32 with respect to body 34. In the example illustrated, catch 38 comprises a resiliently biased member that engages a detent in post 32. Catch 38 inhibits accidental separation of post 32 from body 34. Catch 38 further provides a tactile and audible (in some implementations) indication of when post 32 is fully connected to body 34 of tree connect 30. In other implementations, catch 38 may be omitted.

In the example illustrated, body 34 of tree connect 30 is releasably connected to support post 32, allowing support post 32 to be disconnected from body 30 and separated from tree trunk 22 while tree connect 30 remains attached to tree trunk 22. Likewise, such an arrangement enables tree connect 30 to be pre-mounted to tree trunk 22 independent of support post 32. In other implementations, tree connect 30 may have other configurations. For example, in other implementations, tree connect 30 may alternatively comprise a claw or other tree gripping member. In other implementations, tree connect 30 may be fastened, welded, integrally connected to or otherwise joined to support post 32 such that support post 32 and tree connect 30 are concurrently mounted to tree trunk 22 and concurrently removed from tree trunk 22 as a unit. In such an implementation, catch 38 may be omitted.

Support post 32 comprises one or more structures extending from tree connect 30 vertically along a tree trunk 22. Tree stand post 32 serves as a backbone, spine or rigid support member configured to extend along tree trunk 22 in a vertical direction. Support post 32 supports one or more platforms. In the example illustrated, support post 32 supports two platforms: a seat platform 26 and foot platform 28. In other embodiments, tree stand post 32 may secure and mount a greater or fewer of such platforms. For example, in other embodiments, seat platform 26 may be omitted.

Support post 32 has the general shape of an I-beam, comprising a rear plate portion 40, a front plate portion 42 and an intermediate plate or web portion 44. Rear plate portion 40 is connected to tree connect 30 and confronts the side of trunk 22 when support 24 is mounted to tree trunk 22. In the example illustrated, rear plate portion 40 is releasably connected to tree connect 30. In other implementations, rear plate portion 40 may be fastened, welded, integrally formed as a single unitary body with body 34 or otherwise joined to tree connect 30 in a permanent fashion as a single unit. Rear plate portion 40 comprises a tree confronting rear face 46 that faces a tree trunk 22 when supported along tree trunk 22 by tree connect 30. Because rear face 46 confronts tree trunk 22, the mounting of post 24 along tree 22 does not form a sound reverberating tube. Front plate portion 42 comprises a plate extending parallel to rear plate portion 40.

Intermediate web portion 44 interconnects and extends perpendicular to rear plate portion 40 in front plate portion 42. In the example illustrated, intermediate web portion 44 comprises open celled web portions 50 and slotted web portion 52. Open celled web portions 50 extend on opposite sides of slotted web portion 52, above slotted web portion 52 and below slotted web portion 52. Open celled web portions 54 each comprise a spider-like web of cell walls 54 forming or defining cell openings 56. Cell openings 56 completely extend through the intermediate web portion 44 in a transverse direction, a direction that is horizontal when post 32 is supported adjacent to tree trunk 22 and that extends parallel to plate portions 40, 42, perpendicular to the side edges of plate portions 40, 42. Cell openings 56 horizontally extend through the intermediate web portion 44, tangent to the circumferential cross-section of tree trunk 22 when support post 24 is supported along tree trunk 22 by tree connect 30. Cell openings 56 are sized so as to extend across at least 50% and nominally at least 75% of the distance between and inside forwardly facing face of rear leg portion 40 and an inside rearwardly facing face of front plate portion 42, along a line perpendicular to rear plate portion 40 and front plate portion 42. As shown by FIG. 1, the provision of cell openings 56 along the face of intermediate web portion 44 is extensive, comprising at least a majority of the transversely facing face of intermediate web portion 44 and nominally at least two thirds of the transversely facing faces of intermediate web portion 44. The series of cell openings 56 continuously extend and alternate from a top to a bottom of post 32 but for the provision of slotted portion 52. The cell wall 56 forming a side of one of cell openings 56 also formed a side of and adjacent cell opening 56. Due to the extent to that cell openings 56 are provided along intermediate web portion 44, the weight of support post 32 is greatly reduced, providing tree stand 20 with lighter weight and easier transport.

In addition to lowering the weight of support post 32, cell openings 56 further transmit light. As a result, nature or the background environment may be seen through such cell openings 56. Cell openings 56 further breakup any shadows produced by support post 32. As a result, tree post 32 is camouflaged, being much less conspicuous to wildlife, enhancing wildlife observation and hunting.

In the example illustrated, cell openings 56 formed by cell walls 54 are triangular. In the example illustrated, the lower portion of post 32 below slotted portion 52 comprises six similarly sized triangular openings, wherein each opening has a base of at least 2 inches and a height of at least 1 inch, wherein each opening has an area of at least one square inch. The six similarly sized triangular openings are arranged with three of the openings pointing towards rear plate portion 40 and three pointing towards front plate portion 42. The triangular shape of cell walls 56 form trusses that provide enhanced strength while occupying less surface area, allowing the size of cell openings 56 to be larger, allowing greater amount of background environment to be seen through cell openings 56 and reducing shadows to camouflage support post 32. In other implementations, cell openings 56 may have other shapes. For example, cell openings 56 may alternatively be provided by an intermediate web portion 44 that is honeycombed, providing a honeycomb of openings transversely extending through the intermediate web portion 44. In yet other implementations, cell openings 56 may be circular, square, rectangular or other shapes.

Slotted web portion 52 comprises a portion of intermediate web portion 44 to connect to platform support line 29 to support platform 28. Slotted web portion 52 extends perpendicular to the rear plate portion 40 in front plate portion 42. Slotted web portion 52 comprises a slot 60 which extends through the slotted web portion 52. Slot 60 is located between plate portions 40, 42, extending through the intermediate web portion 44 in a transverse direction, horizontal and perpendicular to the centerline 61 of tree trunk 22, and tangent to the circular cross-section of tree trunk 22 when post 32 is supported by tree connect 30 along tree trunk 22. Slot 60 includes a plurality of longitudinally spaced hooks or notches 62. Notches 62 facilitate retention of various structures at different vertically spaced locations longitudinally along post 32. In the example illustrated, notches 62 receive platform support line 29. Notches 62 facilitate the supporting of foot platform 28 at different angles with respect to post 32. Because notches 62 are formed as part of the intermediate plate portion 54, additional structures for providing such notches 62 may be omitted.

In one implementation, rear plate portion 40, front plate portion 42 and intermediate web portion 44 are integrally formed as part of a single unitary body such as by casting. As a result, support post 32 lacks fastened connections or joints which may move relative to one another in response to encountering load, wherein such movement may create undesirable noise. In one implementation, rear plate portion 40, front plate portion 42 and intermediate web portion 44 are formed from a cast aluminum. In other implementations, support post 32 may be formed from other materials and may have other configurations.

Seat platform 26 comprises a platform mounted to post 32 that is configured to be sat upon by a person using tree stand 20. In the example illustrated, seat platform 26 comprises a perforate platform pinned or bolted to an upper end of post 32 such that platform 26 may be pivoted between a withdrawn position against tree trunk 22 in an orientation substantially parallel to post 32 and an extended position substantially perpendicular to post 32 as shown. Seat platform 26 includes an adjustable set screw on its lower side bearing against post 32 when seat platform 26 is in the extended, in use position. In other embodiments, seat platform 26 may have other configurations or may be omitted.

Foot platform 28 comprises a platform mounted to a lower end of post 32. Foot platform 28 provides a surface upon which a person may stand or rest his or her feet. In the example illustrated, foot platform 28 comprises a perforate platform having a rear tree abutting portion 70 that bears against tree trunk 22. Portion 70 stabilizes foot platform 28 against tree 22 and offsets post 24 from tree trunk 22 such that post 24 may be substantially vertical and parallel to tree trunk 22. In other embodiments, foot platform 28 may have other configurations and may be connected to and supported by post 24 and tree trunk 22 in other fashions.

Platform support line 29 comprises one or more flexible lines connecting extended portions 72 of foot platform 28 to post 24 to support foot platform 28 in the extended position shown. In the example illustrated, platform support line 29 comprises a pair of lines having ends 74 fastened to extended portion 72 of foot platform 28 and opposite ends 76 fastened to a pin or two-headed bolt 78 removably received within one of notches 62. By selectively positioning bolt 78 within one of notches 62, an orientation angle of foot platform 28 may be adjusted.

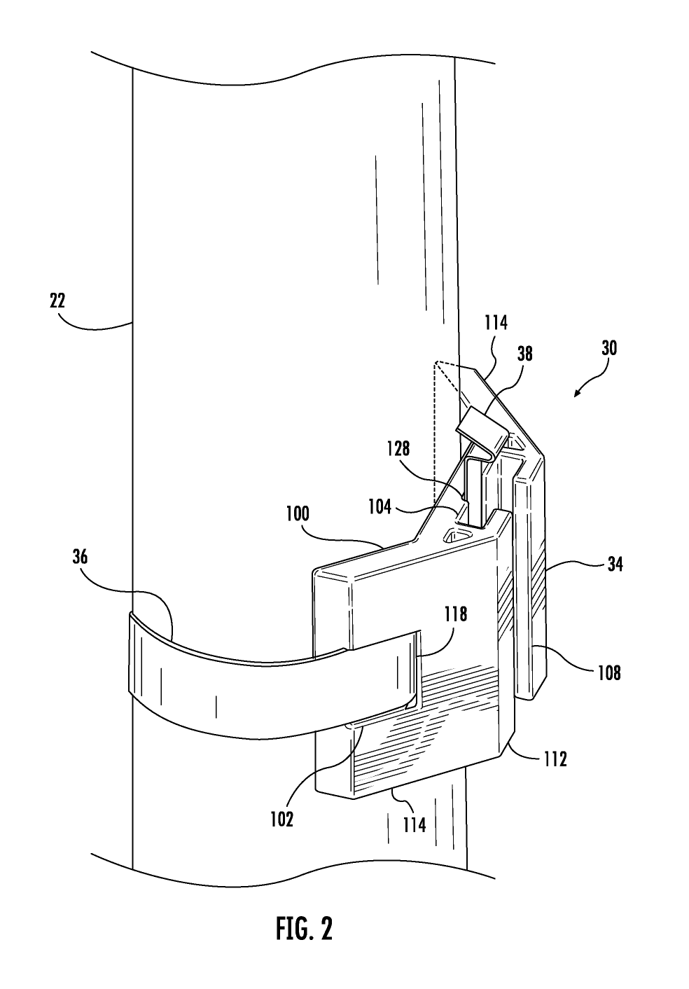

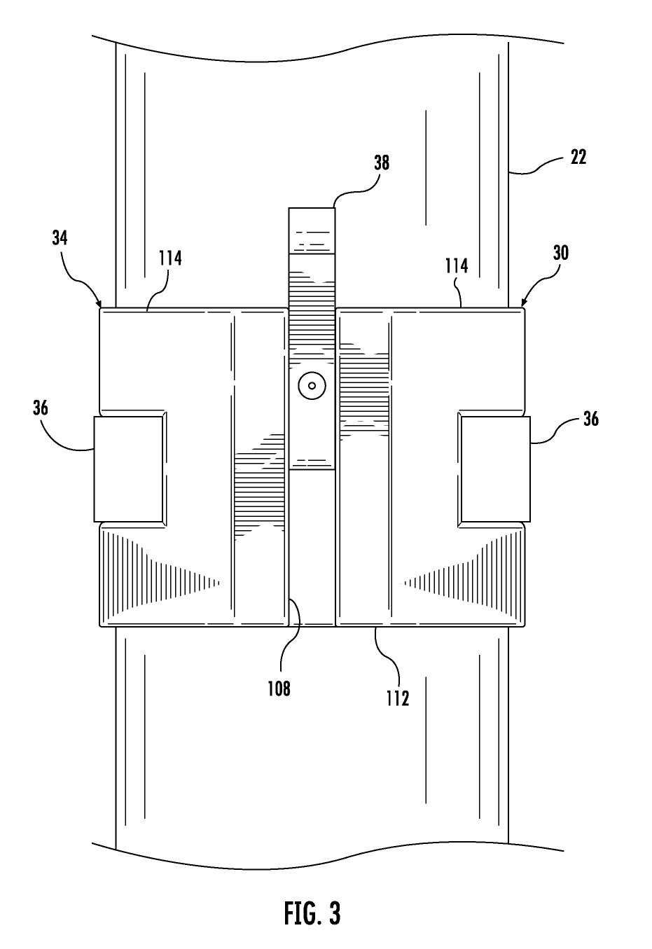

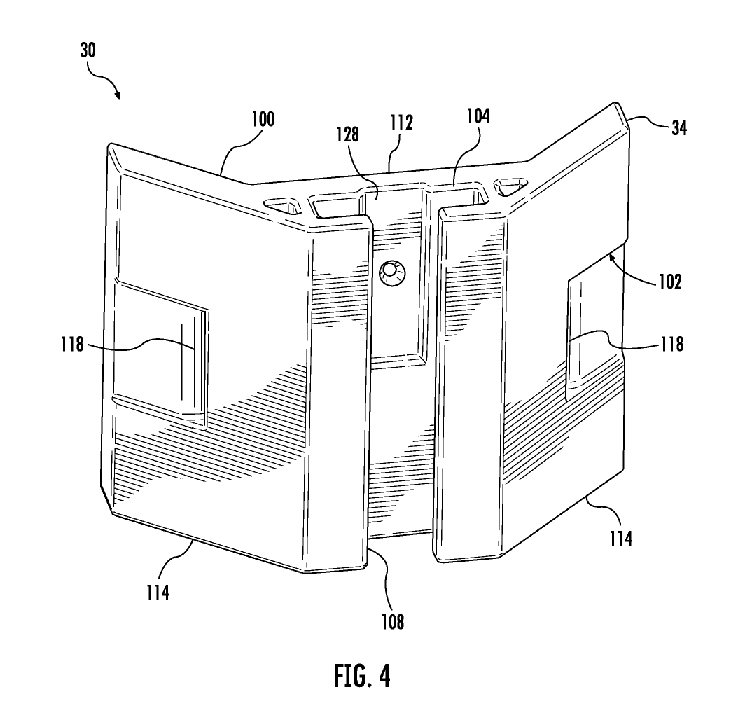

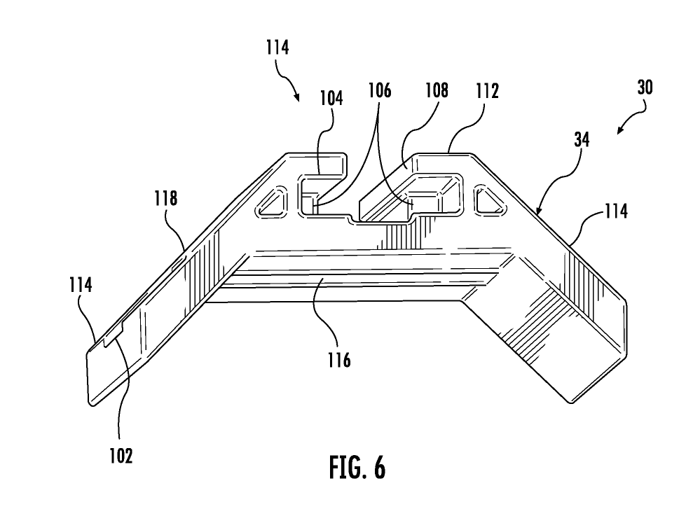

FIGS. 2-10 illustrate tree connect 30 in more detail. FIGS. 2 and 3 illustrate the example tree connect 30 mounted to tree trunk 22 independent of support post 32 (shown in FIG. 1). FIGS. 4-6 illustrate body 34 of tree connect 30 in more detail. As shown by FIGS. 4-6, body 30 comprises a single unitary structure comprising rear tree engagement face 100, tree wrap passage 102, vertical channel 104, floor 106 (shown in FIG. 6) and slot 108. Rear tree engagement face 100 comprises a face to grip and/or wrap about a tree trunk 22 to act as a sway stabilizer. In the example illustrated, tree engagement face 100 forms a concave surface wrapping about a tree trunk 22 (shown in FIG. 2). In the example illustrated, body 34 comprises a main or center portion 112 in a pair of wings 114 that extend from opposite sides of main or center portion 112 to provide face 100 with a polygon a shape. Although illustrated as having a polygonal shaped, face 100 may alternatively be curved. In other implementations, rear tree engagement face 100 may additionally or alternatively include one or more tree gripping structures such as teeth, pins or the like for enhanced gripping. In other implementations, rear tree engagement face 100 may alternatively simply confront the side of the tree with little or no wrapping about the tree, such as where rear tree engagement face 100 extends in a single flat plane. For example, in one implementation, wings 114 may be omitted, wherein tree wrap 36 connects directly to center portion 112.

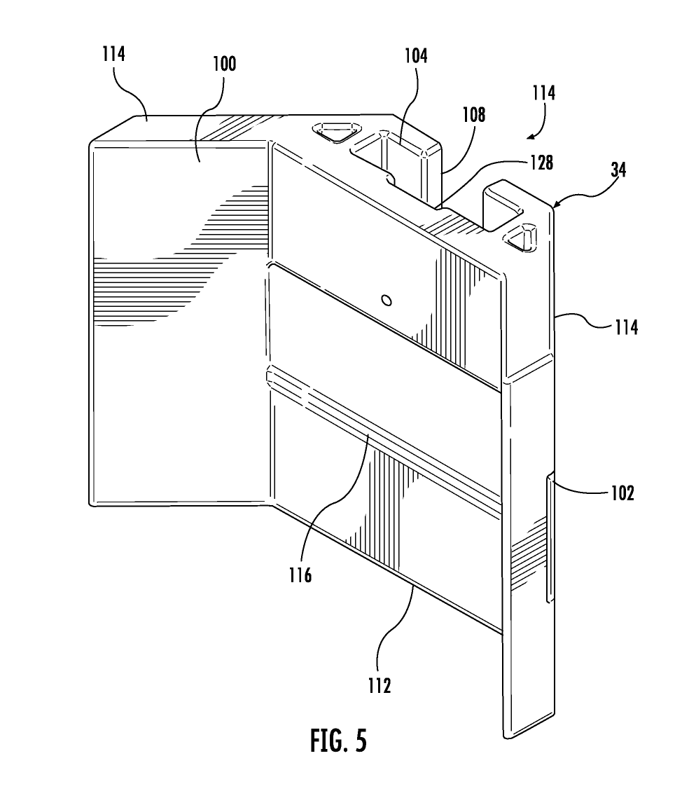

Tree wrap passage 102 comprises a channel in which tree wrap 36 extends and is joined to body 34. In the example illustrated, tree wrap passage 102 comprises a recess 116 (shown in FIG. 5) extending along face 100 backside of center portion 112 and passing through apertures 118 in a front side of wings 114. As a result, tree wrap 36 extends completely across main portion 112 and partially along a front face of wings 114. In implementations where wings 114 flex with respect to center portion 112, tree wrap passage 102 allows to wrap 36 to flex wings 114 about an against the outer circumference of tree trunk 22. In other implementations, tree wrap passage 102 may have other configurations. For example, in other implementations, tree wrap passage 102 may alternatively comprise a pair of structures by which ends of tree wrap 36 are connected to body 34 rather than tree wrap 36 extending across, through and about body 34.

Vertical channel 104 comprises a passage, track or channel extending into a top of body 34 in center portion 112. Vertical channel 104 is sized to slidably receive a head of a tongue or projection extending from support post 32 to facilitate connection of post 32 to body 34. Floor 106 extends within channel 104 on opposite sides of slot 108. Floor 106 faces upwardly so as to underlie the tongue or projection extending from support post 32 when the tongue or projection is received within channel 104. As a result, gravity assists in maintaining the head of the tongue or projection within channel 104 and assists in maintaining connection of support post 32 (shown in FIG. 1) to body 34 of tree connect 30.

Slot 108 comprises an opening or passage extending through front 114 of center portion 112 into communication with vertical channel 104. Slot 10 a vertically extends along center portion 112. Slot 108 is configured (sized and shaped) to slidably receive a neck of the tongue while the head of the tongue, supported by the neck, slides within vertical channel 104. Slot 108 facilitates easier alignment and connection of support post 32 to tree connect 30. In particular, connection merely involves alignment of the tongue extending from tree post 32 with the front facing slot, followed by vertical movement of the tree post 32 along a front of center portion 112 of body 34 until the head of the tongue rests upon floor 106. Alignment in a transverse direction is facilitated by viewing of the edges of slot 108. Alignment in the fore and aft direction (perpendicular towards and away from the side of tree trunk 22) is facilitated by abutment of the head of the tongue with the back face of vertical channel 104. Such connection is facilitated without the use of tools or other implements and may be manually completed. In other implementations, tree connect 30 may have other configurations to facilitate releasable connection of tree connect 30 to tree post 32.

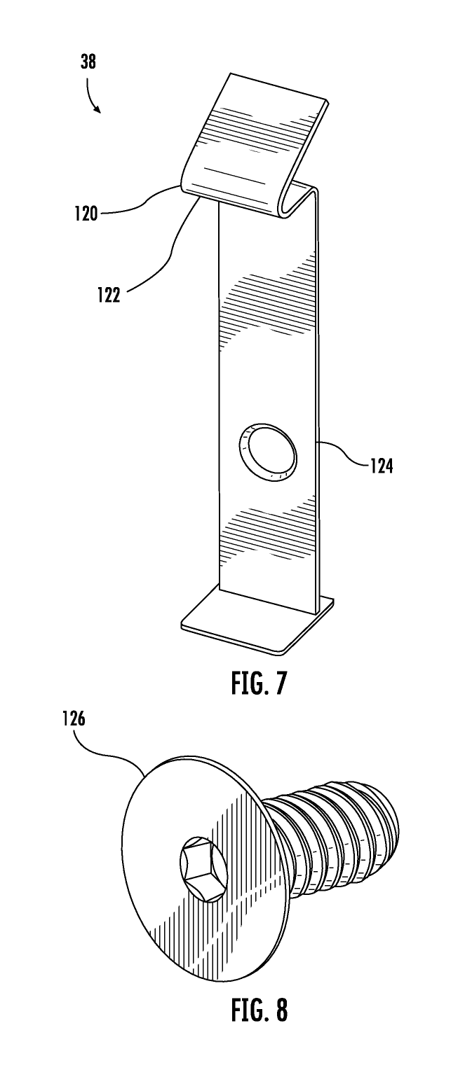

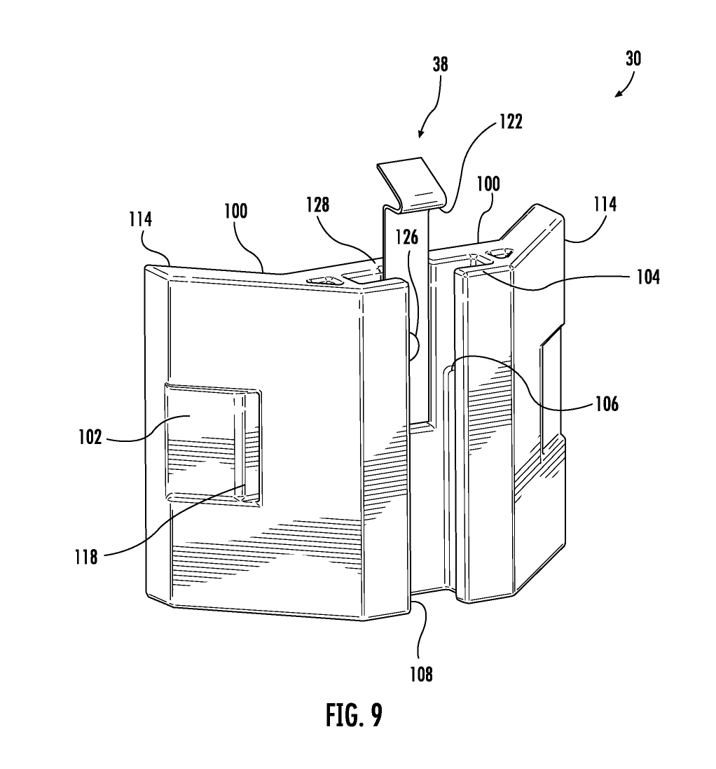

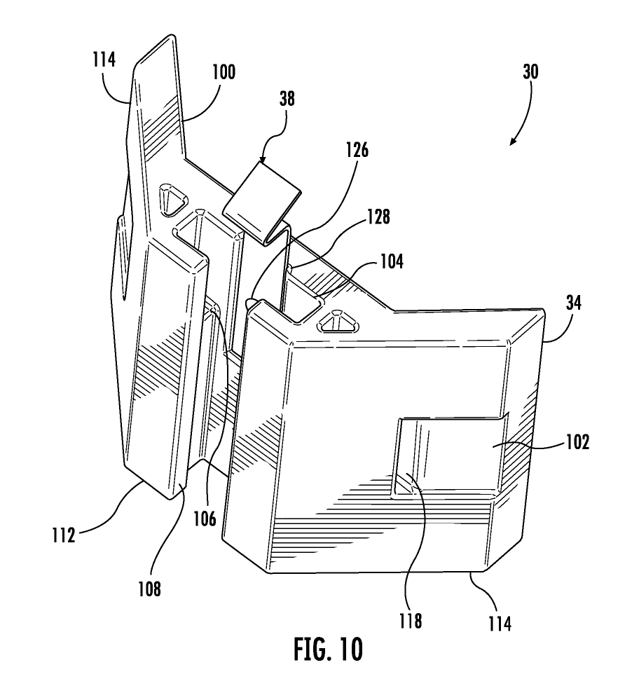

FIGS. 7-10 illustrate catch 38 in more detail. As shown by FIG. 7, in the example illustrated, catch 38 comprises a spring steel or spring metal band having a deformed or bent end portion 120 forming a catching service or hook 122. The band of spring metal further comprises an opening 124 to facilitate fastening of catch 28 to body 34 using a faster, such as faster 126 shown in FIG. 8. As shown by FIGS. 9 and 10, the band of spring metal is fastened within a detent 128 formed within the back face of vertical channel 104 in center portion 112. When mounted, hook 122 faces forward, away from tree engagement face 100 for engaging portions of tree post 32 when the tongue extending from tree post 32 is received within vertical channel 104. As noted above, catch 38 provides a tactile and an audible indication of when the head of the tongue has been fully inserted into vertical channel 104 so as to rest upon floor 106. 38 further inhibits accidental upward relative movement of tree post 32 with respect to tree connect 30. Although catch 38 is illustrated as being attached to body 34, in other implementations, catch 38 may be integrally formed as part of a single unitary body with body 34 or maybe mounted to body 34 in other fashions or in other locations. Although illustrated as comprising a spring metal, catch 38 may alternatively be formed from other materials and may have other configurations.

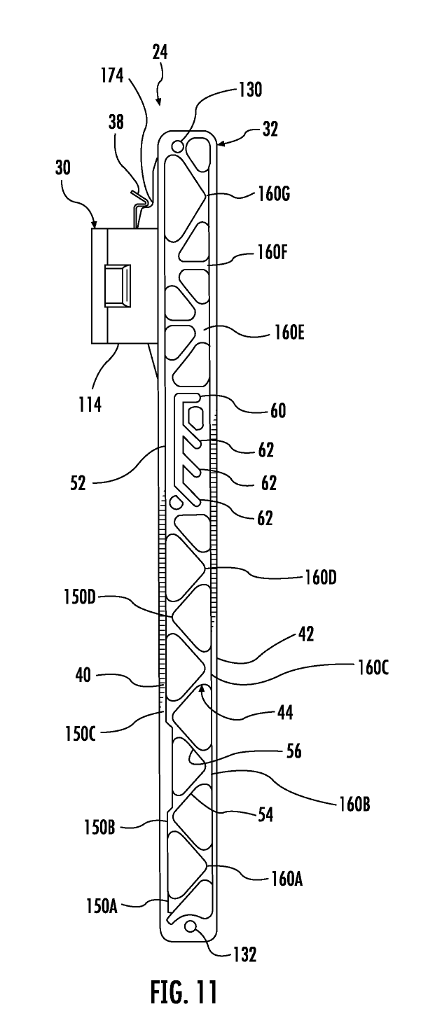

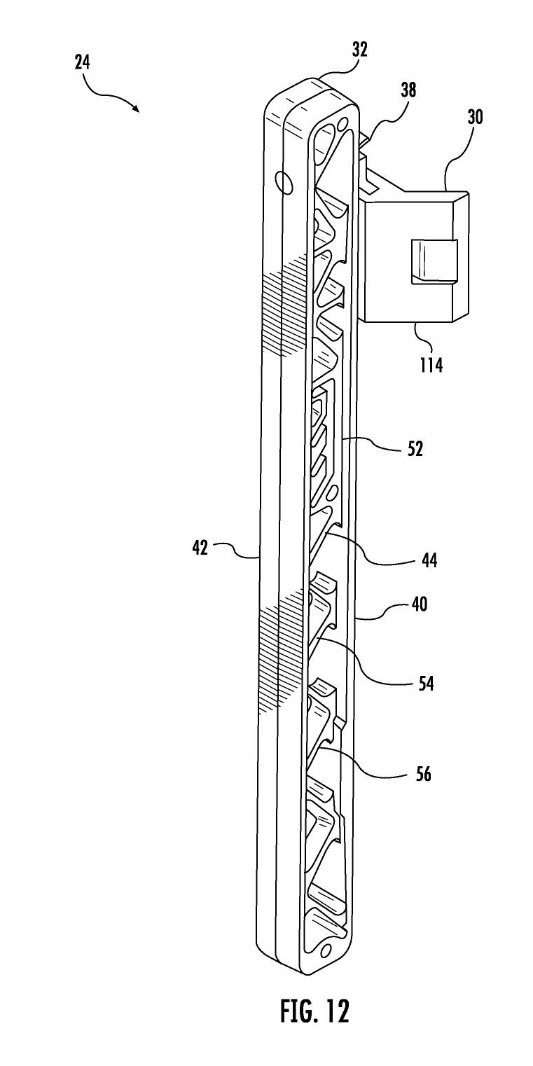

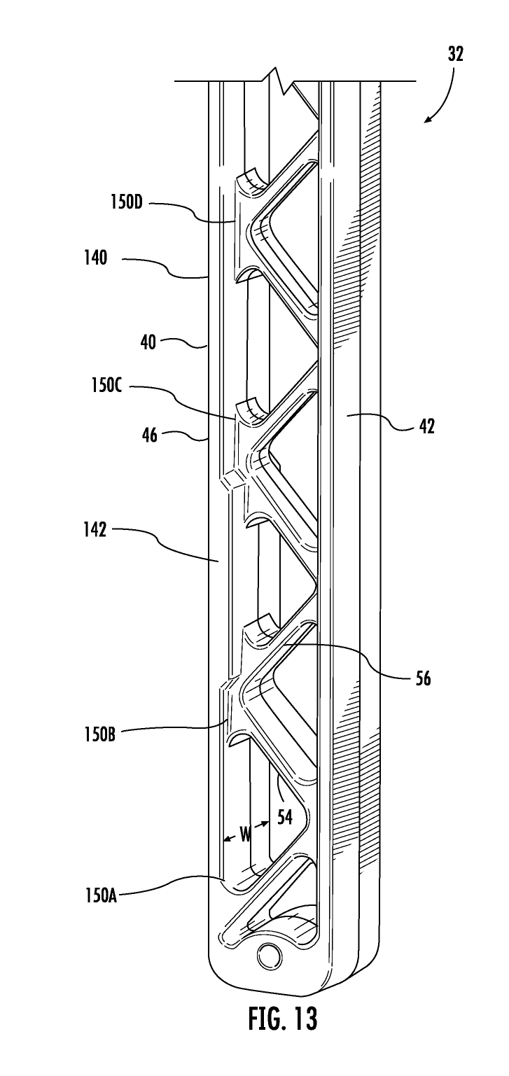

FIGS. 11-17 illustrate tree post 32 in more detail. FIGS. 11 and 12 illustrate tree post 32 connected to tree connect 30 (with tree wrap 36 omitted). As shown by FIGS. 11 and 12, tree post 32 comprises upper aperture 130 and lower aperture 132. Upper aperture 130 comprises a transverse opening through the intermediate web portion 44 for pivotal securement of seat platform 26. Lower aperture 132 comprises a transverse opening through the intermediate web portion 44 for pivotal securement of foot platform 28.

FIGS. 13-16 illustrate rear plate portion 40 and intermediate web portion 44 of support post 32 in more detail. As shown by FIG. 13, rear plate portion 40 has a varying thickness (thickness measured in a direction perpendicular to tree confronting face 46 of rear plate portion 40). In the example illustrated, rear plate portion 40 comprises thinner regions 140 and a thicker region 142 between slotted web portion 52 and a bottom of post 32. Thicker region 142 provides enhanced strength of those regions of post 32 which incur stress and strain when supporting weight.

As further shown by FIG. 13, each of the cell walls 54 forming the cell openings 56 are joined at one end to rear plate portion 40 and at the other end to front plate portion 42 by bases or feet 150A, 150B, 150C, 150D (collectively referred to as feet 150). Feet 150 comprise those portions of cell walls 54 that are connected to the adjacent plate portions 40, 42. Each foot 150 has a transverse width corresponding to or substantially equal to the transverse width of the cell walls 54 interconnected by the particular foot 150. In the example illustrated, feet 150 have different transverse widths depending upon the positioning of the individual foot 150 along post 32. Likewise, those cell walls extending from different feet 150 also have corresponding different transverse widths. No In the example illustrated, post 32 comprises a first foot 150A having a transverse width W substantially equal to the transverse width of rear plate portion 40, a second foot 150B having a transverse width less than the transverse width of foot 150A, a third foot 150C having a transverse width less than the transverse width of foot 150B and a fourth foot 150D having a width equal to the width of foot 150C. Feet 150B and 150C each intersect opposite end portions of the region 142. Regions of rear plate portion 40 proximate to a top of post 32 have a similar varying with distribution with those feet closer to a top of post 32 having a greater width. By varying the width of feet 150 (and the associated cell walls 54), post 32 may be provided with differing strength capacities were engineered strength in critical weight bearing areas along a length of post 32 to accommodate larger loads with less material or structure. Because the strength of different portions of post 32 along the length of post 32 is dynamically engineered, portions of post 32 may be made thinner while other portions of post 32 are thicker (such as thicker region 142 and wider feet 150) to achieve optimal strength distribution and weight. By varying the strength (and weight) of post 32 by adjusting the transverse width of cell walls 54, rather than the thickness of cell walls 54, weight and strength distribution may be less conspicuously optimized, allowing a greater amount of background environment to be seen through the intermediate web portion 44 for enhanced camouflaging of post 32

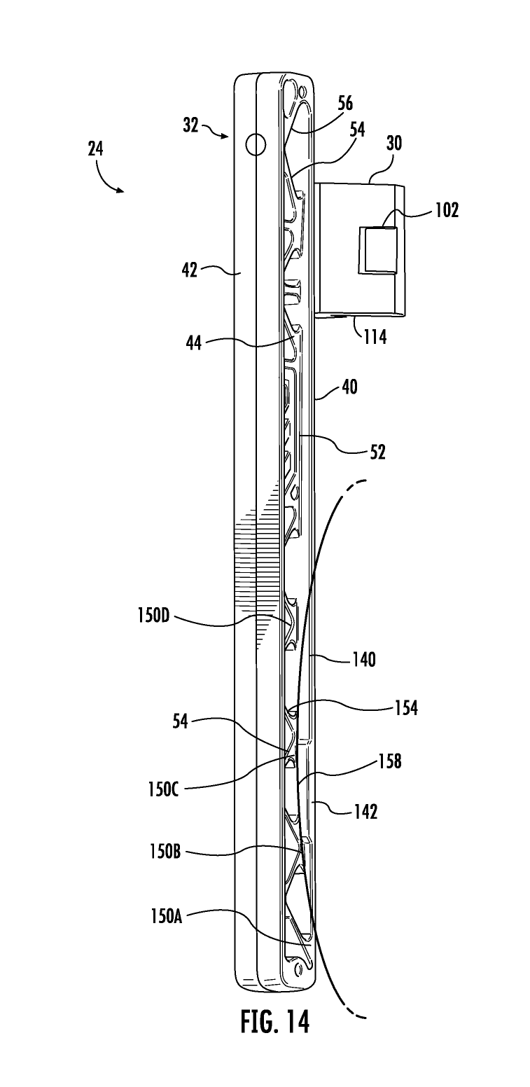

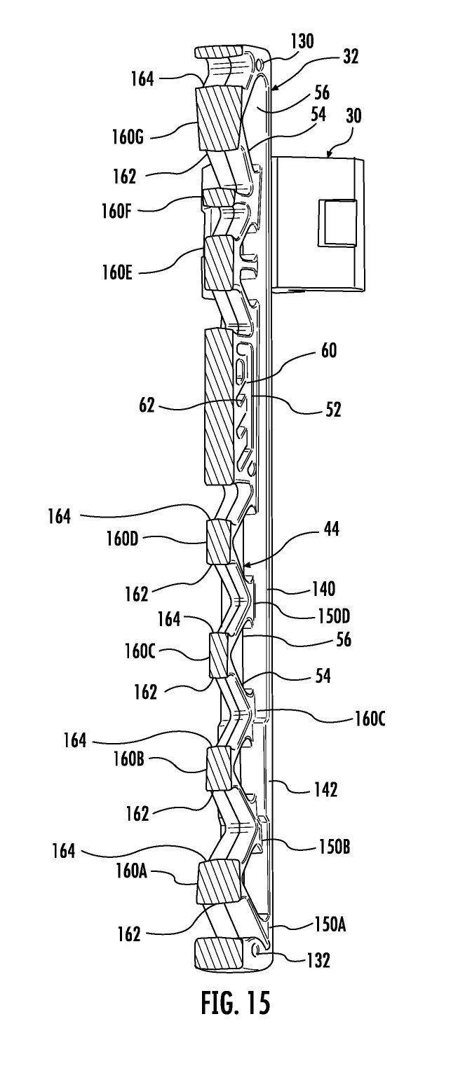

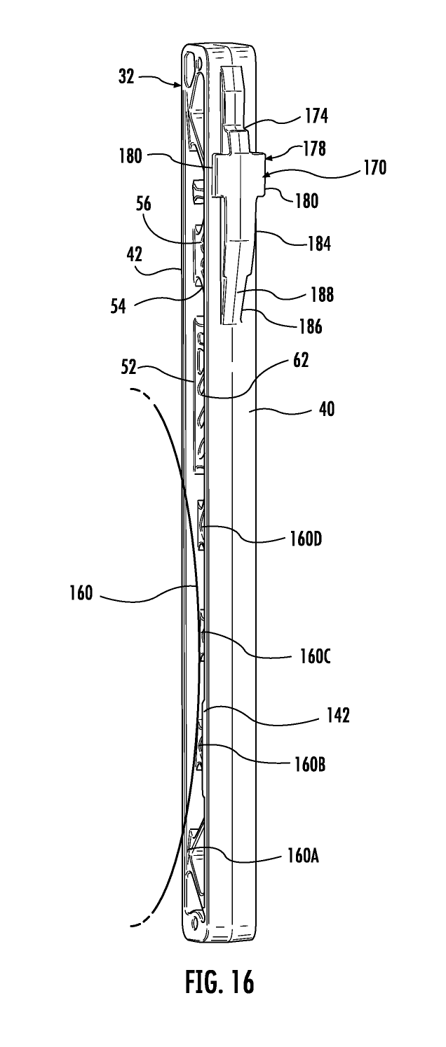

FIGS. 14-16 further illustrate the collective layout or architecture of feet 150 along the length of post 32. As shown by FIGS. 14 and 16, not only do feet 150 have different transverse width, but feet 150 and the associated cell walls 54 are shaped such that the two opposite transverse sides or faces of intermediate web portion 44 formed by the collective transverse side faces or side edges 154 of cell walls 56 have a concave shape. As shown by FIG. 14, the right side edges of cell walls 54 extend along an arc 158 to form a rightward facing concavity. As shown by FIG. 16, the left side edges of cell walls 54 also extend along an arc 160 to form a leftward facing concavity. As shown by FIG. 15 which is a sectional view illustrating the post 32 of FIG. 14 with the front plate portion 42 omitted, feet 150 connecting cell walls 54 to front plate portion 54 have trapezoidal shapes. In the example illustrated, post 132 further comprises feet 160A, 160B, 160C, 160D, 160E, 160F and 160G. Feet 160A and 160B have trapezoidal shapes with the lowermost edges 162 having transverse widths greater than the topmost edges 164 of the same feet 160. Foot 160C is substantially rectangular, wherein the lowermost edges 162 and the topmost edge 164 having the same widths. Foot 160D is on an opposite side of the arc such that it has a lowermost edge 162 having a transverse width that is less than a transverse width of its topmost edge 164. Foot 160G has a trapezoidal shape with its lowermost edge 162 having a transverse width less than the transverse width of its uppermost edge 164. By shaping feet 150, 160 such that the side faces of cell walls 54 and of feet 150, 160 form a side facing collective concavity along a substantially smooth arc on inside of intermediate web portion 44, loads are more uniformly distributed along the vertical length of post 32, reducing sharp points of stress and strain. In other implementations, the widths of feet 150, 160 and interconnecting cell walls 52 may alternatively be varied in a stepwise fashion along the vertical length of post 32. In other implementations, the concavity formed on each side of intermediate web portion 44 may alternatively be applied to a substantially imperforate intermediate web portion 44, lacking cell openings 56.

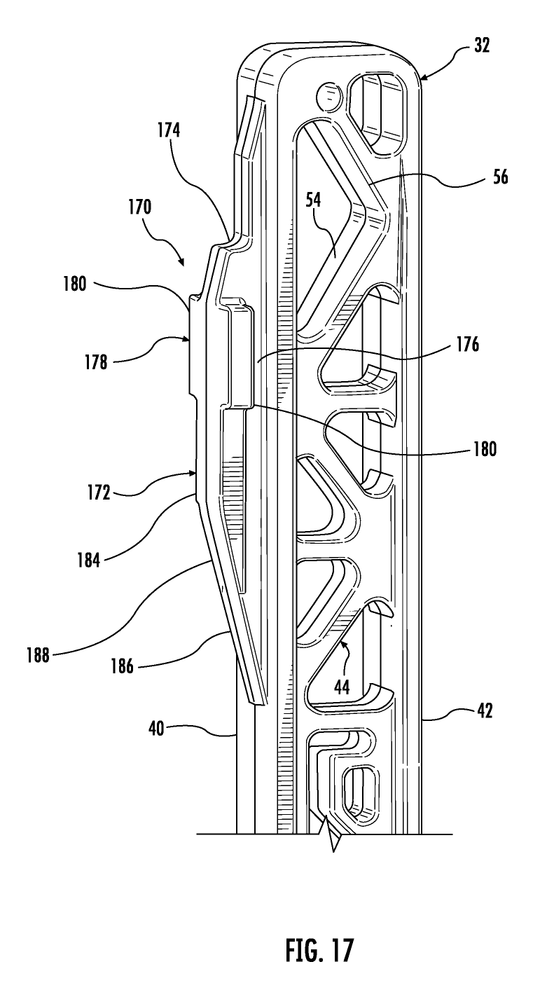

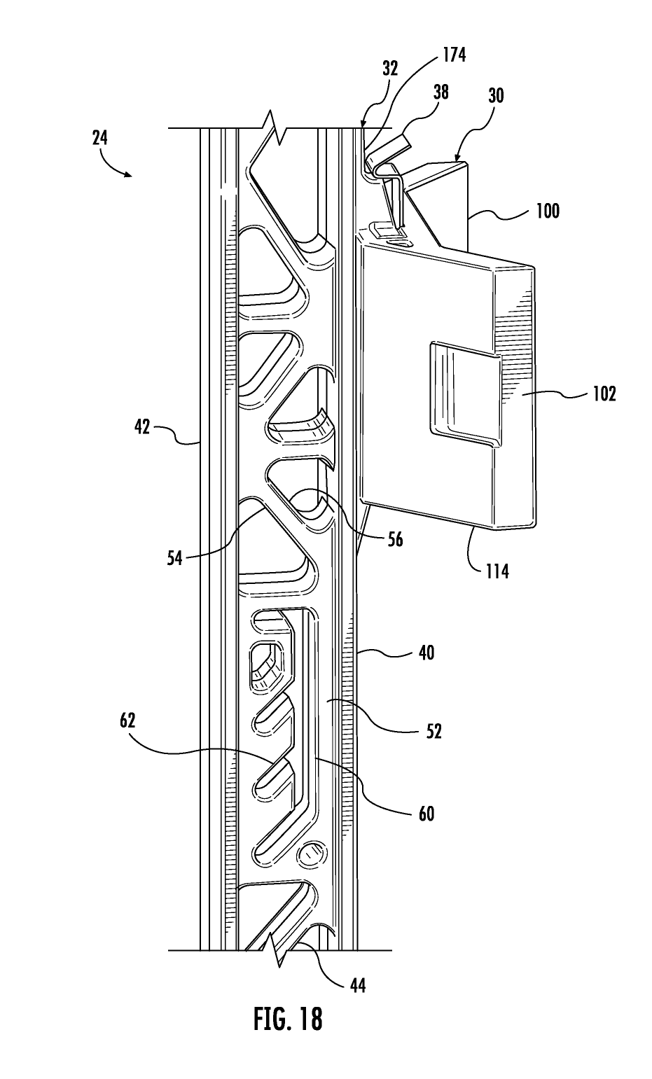

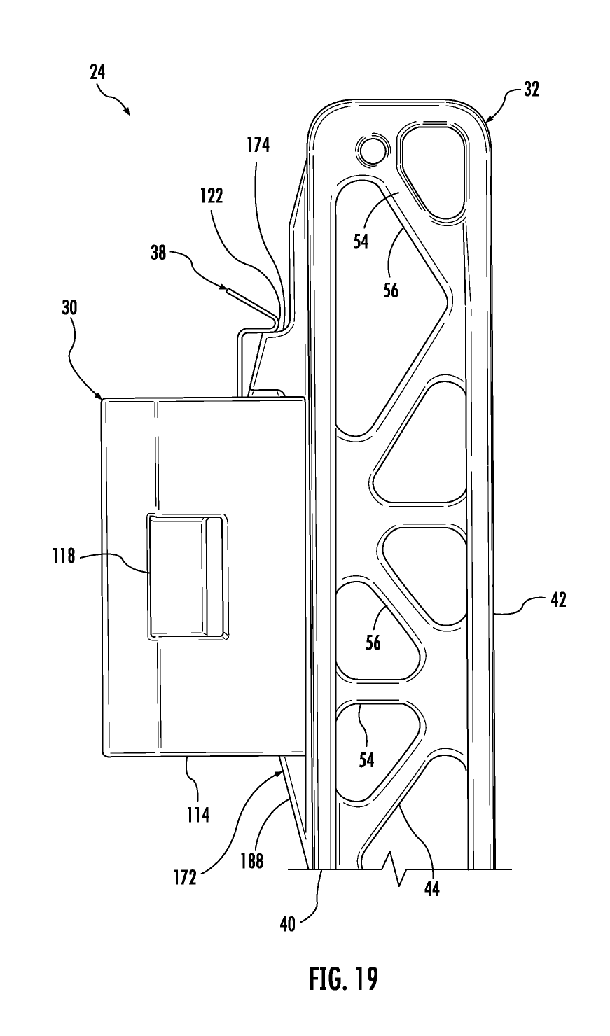

As shown by FIGS. 16 and 17, post 32 additionally comprises a tongue 170, alignment bar 172 and detent 174. Tongue 170 is located proximate an upper end of post 32. Tongue 170 is configured to slidably pass through slot 108 and to slide within vertical channel 104 until being lowered into abutment with floor 106. Tongue 170 facilitates releasable and quick connection of post 32 to tree connect 30 without the use of tools or fasteners. Tongue 170 further facilitates quick and easy alignment for easier connection.

As shown by FIGS. 16 and 17, tongue 170 comprises neck 176 (shown in FIG. 17) and head 178. Neck 176 projects rearwardly from rear plate portion 40 in front of head 178. Neck 176 supports head 178 and is sized to pass through an slide within slot 108.

Head 178 comprises an enlarged structure extending forward of or on top of neck 176. Head 178 is sized so as to extend transversely beyond neck 176 such that had 178 cannot pass through slot 108, but such that head 178 is slidably receivable within vertical channel 104 but cannot pass through or below floor 106. In the example illustrated, had 178 comprises two extensions 180 projector extending from opposite sides of neck 176. In the example illustrated, the two projections extend perpendicular to neck 176 such that tongue 170 has a T-shaped cross-section. In other implementations, head 178 may have other shapes. For example, head 178 may have other shapes such that tongue 170 alternatively has a Y-shaped cross-section; a [symbol] cross sectional shape and a ↑ cross sectional shape.

Alignment bar 172 comprises a structure extending below tongue 170, from neck 176 towards a bottom of post 32. Alignment bar 172 facilitates alignment and insertion of tongue 170 within vertical channel 104 of tree connect 30 (shown in FIG. 4). In the example illustrated, alignment bar 172 has a transverse width such that alignment bar 172 may pass through slot 108 and slide along slot 108. In the example illustrated, alignment bar 172 has a first region 184 having a transverse width substantially equal to the transverse width of neck 176 and a second region 186, vertically below the first region 184 and having a transverse width less than the transverse width of first region 184. The narrower transverse width of second region 186 facilitates initial alignment of alignment bar 172 with slot 108 while the increased transverse width of first region 184 facilitates more precise alignment of alignment bar 172 with slot 108. In the example illustrated, the different widths of regions 184, 186 have a stepped transition therebetween. In another implementation, the different widths of regions 184, 186 may have a tapered or sloped transition therebetween.

As further shown by FIGS. 16 and 17, alignment bar 184 additionally comprises a downwardly ramped or sloped rearward surface 188. Surface 188 further facilitates alignment and insertion of alignment bar 72, and tongue 170, into slot 108 with the head 178 sliding within channel 104. In other implementations, service 188 may be omitted, the varying with of regions 184, 26 may omitted or alignment bar 172 itself may be omitted.

Detent 174 comprises a notch supported by post 32 vertically above head 178. Detent 174 is configured to releasably receive hook 122 of catch 38. Detent 174 is located such that hook 122 is only received when tongue 178 has been fully inserted into channel 104 with lowermost surfaces of head 178 resting upon and in contact with floor 106. When tongue 1/70 and fully inserted into tree connect 30, catch 38 snaps into place into detent 174 indicating complete insertion. Catch 38 further provides a resilient spring bias, inhibiting inadvertent upward movement of post 32 relative to tree connect 30. In other implementations, detent 174 as well as catch 38 may be omitted.

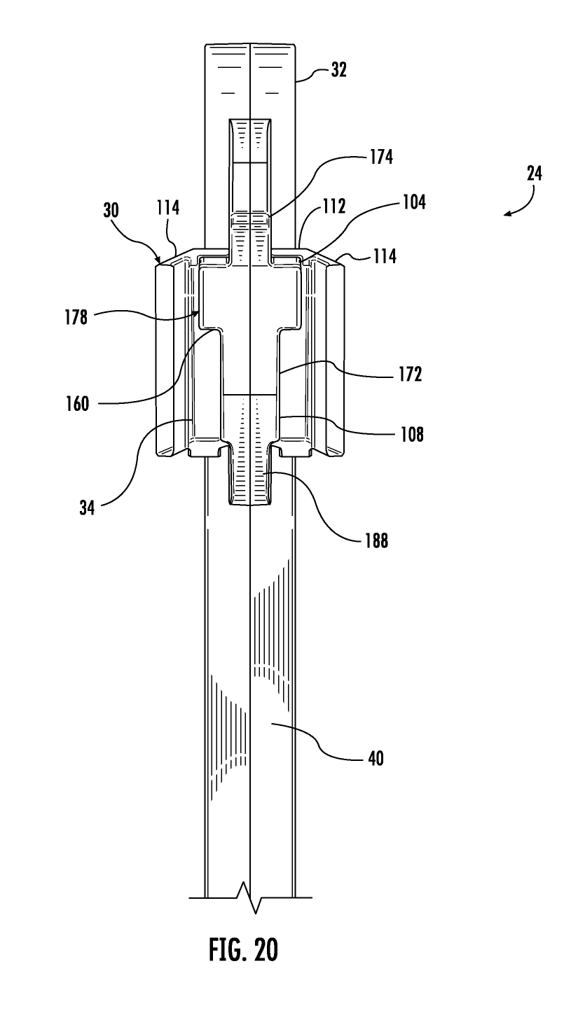

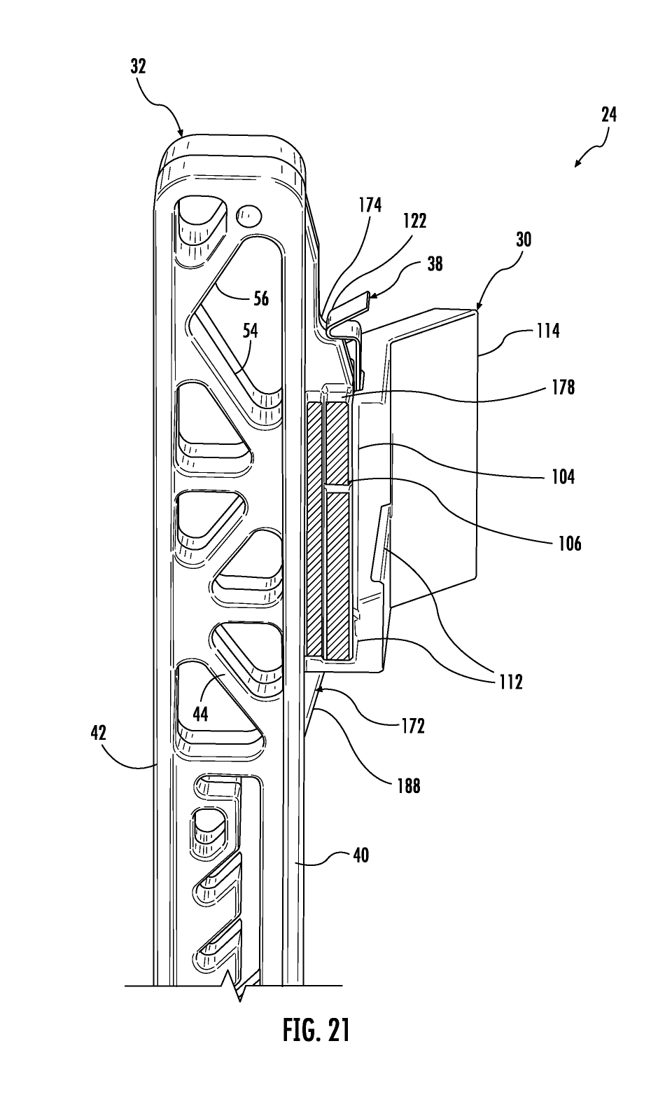

FIGS. 19-21 illustrate the interconnection of post 32 and tree connect 30 in more detail. As shown by FIG. 19, when tongue 170 of post 32 has been aligned with and fully lowered into slot 108 until head 178 comes to rest upon floor 106 within channel 104, book 122 of catch 38 automatically resiliently snaps into detent 174. FIG. 20 is a sectional view illustrating had 178 resting upon floor 106 within vertical channel 104 while alignment bar 172 extend within slot 108 of body 34 of tree connect 30. FIG. 21 is another sectional view illustrating complete insertion of tongue 170 into slot 108 and channel 104 of tree connect 30. As shown by such figures, tongue 170 and tree connect 130 facilitates easy connection (or disconnection) of post 32 and tree connect 30.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a tree stand platform support comprising:
a post comprising:
a first plate portion;
a second plate portion parallel to the first plate portion; and
an intermediate open celled web portion interconnecting and extending perpendicular to the first plate portion and the second plate portion, the intermediate open celled web portion having cell walls forming cell openings through the intermediate open celled web portion.

2. The apparatus of claim 1, wherein a majority of a face of the intermediate open celled web portion comprises the cell openings.

3. The apparatus of claim 1, wherein the cell openings extend proximate a top of the post in a bottom of the post.

4. The apparatus of claim 1, wherein the cell openings are triangular.

5. The apparatus of claim 4, or the openings comprise oppositely directed triangles.

6. The apparatus of claim 1, wherein the first plate portion has a transverse width between opposite edges of the first plate portion and wherein the cell walls have a varying transverse width.

7. The apparatus of claim 6, wherein the cell walls comprise a first cell wall having a transverse width equal to the transverse width of the first plate portion.

8. The apparatus of claim 7, wherein the cell walls comprise a second cell wall having a transverse width less than half the transverse width of the first plate portion.

9. The apparatus of claim 1, wherein the cell walls are joined to the first plate portion by a foot, wherein the foot has a trapezoidal shape.

10. The apparatus of claim 1, wherein the cell walls have outer faces collectively forming a concave face of the intermediate plate portion.

11. The apparatus of claim 1, wherein the intermediate open celled web portion comprises a slot forming a plurality of spaced notches.

12. The apparatus of claim 1, wherein the first plate portion has a rear face to confront a tree.

13. The apparatus of claim 12, wherein the post further comprises a tongue having a neck extending from the rear face and a head supported by the neck.

14. The apparatus of claim 13, wherein the tongue is integrally formed as a single unitary, homogenous body with the first plate portion.

15. The apparatus of claim 13, wherein the head comprises a first extension extending from a first side of the neck and a second extension extending from a second side of the neck.

16. The apparatus of claim 15, wherein the tongue has a cross sectional shape selected from a group of cross sectional shapes consisting of: a T-shaped cross-section; a Y-shaped cross-section; a [symbol] cross sectional shape and a ↑ cross sectional shape.

17. The apparatus of claim 13 further comprising an alignment bar extending from the neck towards a bottom of the post.

18. The apparatus of claim 17, wherein the alignment bar has a sloped rearward facing surface.

19. The apparatus of claim 17, wherein the neck has a first transverse width and wherein the alignment bar has a second transverse width less than the first transverse width.

20. The apparatus of claim 13, wherein the tree stand platform support further comprises a tree connect to mount the post to a tree, the tree connect releasably connected to the post, the tree connect comprising:
a body having a rear tree engagement face to abut the tree;
a vertical channel extending into a top of the body to slidably receive the head of the tongue;
a slot through a front of the body in connection with the channel to slidably receive the neck of the tongue; and
a floor within the channel to underlie the head when the tongue is received within the channel.

21. The apparatus of claim 20, wherein the post comprises a detent and wherein the tree connect further comprises a resiliently biased catch extending from the body of the tree connect into engagement with the detent of the post when the head is received within the channel.

22. The apparatus of claim 1 further comprising a tree connect to mount the post to a tree, the tree connect releasably connected to the post, wherein one of the tree connect and the post comprises a tongue having a neck supporting a head and wherein the other of the tree connect and the post comprises a vertical channel slidably receiving the head, a slot slidably receiving the neck and a floor upon which the head rests when received within the channel.

23. An apparatus comprising:
a tree stand tree connect to mount a tree stand post to a tree, the tree stand tree connect releasably connected to the post, the tree stand tree connect comprising:
a body having a rear tree engagement face to abut the tree;
a vertical channel extending into a top of the body to slidably receive a head of a tongue extending from the post;
a slot through a front of the body in connection with the channel to slidably receive a neck of the tongue extending from the post; and
a floor within the channel to underlie the head when the tongue is received within the channel.

24. The apparatus of claim 23, wherein the tree stand connect further comprises a resiliently biased catch extending from the body of the tree connect to engage a detent of the post when the head is received within the channel.

25. The apparatus of claim 23 further comprising the post, the neck extending from the post and the head supported by the neck.

26. The apparatus of claim 25, wherein the post comprises:
a first plate portion;
a second plate portion parallel to the first plate portion; and
an intermediate portion interconnecting and extending perpendicular to the first plate portion and the second plate portion, wherein the neck extends from the second plate portion perpendicular to the first plate portion.

27. The apparatus of claim 26, wherein the intermediate portion is open celled, the intermediate portion having cell walls forming cell openings transversely extending through the intermediate portion in a direction parallel to the first plate portion.

28. The apparatus of claim 25 further comprising a platform extending from the post.
